(19) United States
(12) Patent Application Publication
(10) Pub. No.: US 2025/0019077 A1
(43) Pub. Date: Jan. 16, 2025

(54) Self Deicing of Aircraft Windows using Lidar

(71) Applicant: The Boeing Company, Arlington, VA (US)

(72) Inventors: Nathan D. Hiller, Irvine, CA (US); Claudia E. Fritz-Thompson, Bothell, WA (US)

(21) Appl. No.: 18/349,214

(22) Filed: Jul. 10, 2023

(51) Int. Cl. B64D 15/20; G01S 17/86; G01S 17/933

(52) U.S. Cl. CPC B64D 15/20; G01S 17/86; G01S 17/933

(57) ABSTRACT

A method for deicing in a laser sensor window in an aerospace vehicle. A deicing laser beam is transmitted from a laser beam generator in the aerospace vehicle into the laser sensor window in the aerospace vehicle. The deicing laser beam has properties that remove ice from the laser sensor window. A sensor laser beam is transmitted from the laser beam generator through the laser sensor window.

### BACKGROUND INFORMATION

### 1. Field

The present disclosure relates generally to aircraft and, in particular, to deicing windows in aircraft using lidar systems.

### 2. Background

Laser-based sensor systems can replace many vital aircraft instruments and add new capabilities for aircraft. For example, a light detection and ranging (LIDAR) sensor can be used to measure the speed of an aircraft. With a lidar sensor, a laser beam is emitted into the air. This laser beam can be emitted through a window of an aircraft.

The laser beam encounters aerosols in the air that reflect or “backscatter” light toward the aircraft. Aerosols are fine solid particles, liquid particles, or both, suspended in air or other gases. The backscatter of the laser beam can also be caused by the molecules of air.

The backscatter light generated in response to emitting the laser beam is detected. The speed of the aircraft can be determined by comparing the frequency of the laser beam to the frequency in the backscatter. This shift in frequency is a Doppler effect that can be used to calculate the speed of the aircraft. These types of laser-based sensor systems can also be used to measure other parameters including temperature and air density during flight of the aircraft.

### SUMMARY

An embodiment of the present disclosure provides a method for deicing a laser sensor window in an aerospace vehicle. A deicing laser beam is transmitted from a laser beam generator in the aerospace vehicle into the laser sensor window. The deicing laser beam has properties that remove ice from the laser sensor window. A sensor laser beam is transmitted from the laser beam generator through the laser sensor window.

Another embodiment of the present disclosure provides a laser sensor system comprising a laser beam generator, a detector system, and a controller. The laser beam generator in an aerospace vehicle is configured to transmit laser beams. The detector system is located in the aerospace vehicle and is configured to detect a backscatter light received in response to transmitted laser beams. The controller is configured to control the laser beam generator to transmit a deicing laser beam from the laser beam generator into a laser sensor window in the aerospace vehicle, wherein the deicing laser beam has properties that remove ice from the laser sensor window and transmit a sensor laser beam from the laser beam generator through the laser sensor window.

Yet another embodiment of the present disclosure provides a laser sensor system comprising a laser beam generator, a detector system, and a controller. The laser beam generator is located in an aerospace vehicle and is configured to transmit laser beams. The detector system is located in the aerospace vehicle and is configured to detect a backscatter light received in response to transmitted laser beams. The controller is configured to control the laser beam generator to transmit a deicing laser beam from the laser beam generator into a laser sensor window in the aerospace vehicle, wherein the deicing laser beam has first properties that remove ice from the laser sensor window. The controller is configured to control the laser beam generator to transmit a sensor laser beam from the laser beam generator through the laser sensor window. The controller is configured to determine a set of parameters for the aerospace vehicle in response to the detector system detecting the backscatter light generated in response to transmitting the sensor laser beam. The controller is configured to determine whether ice is present on the laser sensor window using the backscatter light generated in response to transmitting the deicing laser beam having the first properties. The controller is configured to control the laser beam generator to transmit the deicing laser beam from the laser beam generator into the laser sensor window in response to determining that the ice is present on the laser sensor window in an insufficient amount to degrade performance in using the sensor laser beam to detect a set of parameters for the aerospace vehicle, wherein the deicing laser beam has second properties that generate the backscatter light for detecting chemical elements in an atmosphere. The controller is configured to determine the chemical elements in the atmosphere using the backscatter light detected by the detector system in response to transmitting the deicing laser beam having the second properties.

Still another embodiment of the present disclosure provides a method for deicing a laser sensor window in an aerospace vehicle. A laser beam is transmitted from a laser beam generator in the aerospace vehicle into the laser sensor window, wherein the deicing laser beam has first properties that remove ice from the laser sensor window. A sensor laser beam is transmitted from the laser beam generator through the laser sensor window. A set of parameters is determined for the aerospace vehicle in response to a detector system in the aerospace vehicle detecting a backscatter light generated in response to transmitting the sensor laser beam. A determination is made as to whether ice is present on the laser sensor window using the backscatter light generated in response to transmitting the deicing laser beam having the first properties. The deicing laser beam is transmitted from the laser beam generator into the laser sensor window in response to determining that the ice is present on the laser sensor window in an insufficient amount to degrade performance in using the sensor laser beam to detect a set of parameters for the aerospace vehicle, wherein the deicing laser beam has a second properties that generate the backscatter light for detecting chemical elements in an atmosphere. The chemical elements in the atmosphere are determined using the backscatter light detected by the detector system in response to transmitting the deicing laser beam having the second properties.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft in accordance with an illustrative embodiment;

FIG. 2 is an illustration of a block diagram of a laser sensor environment in accordance with an illustrative embodiment;

FIG. 3 is an illustration of a laser sensor system with automatic deicing in accordance with an illustrative embodiment;

FIG. 4 is an illustration of a more detailed example of a laser sensor system in accordance with an illustrative embodiment;

FIG. 5 is an illustration of laser beam transmission using orthogonal pulsed laser beams in accordance with an illustrative embodiment;

FIG. 6 is an illustration of laser beam transmission using orthogonal continuous wave laser beams in accordance with an illustrative embodiment;

FIG. 7 is an illustration of transmitting a deicing laser beam into a laser sensor window in accordance with an illustrative embodiment;

FIG. 8 is an illustration of transmitting a deicing laser beam into a laser sensor window in accordance with an illustrative embodiment;

FIG. 9 is an illustration of an ice fingerprint in accordance with an illustrative embodiment;

FIG. 10 is an illustration of a flowchart of a process for deicing a laser sensor window in aerospace vehicle in accordance with an illustrative embodiment;

FIG. 11 is an illustration of a flowchart of a process for deicing a laser sensor window in accordance with an illustrative embodiment;

FIG. 12 is an illustration of a flowchart of a process for deicing a laser sensor window in accordance with an illustrative embodiment;

FIG. 13 is an illustration of a flowchart of a process for deicing a laser sensor window in accordance with an illustrative embodiment;

FIG. 14 is an illustration of a flowchart of process for transmitting a deicing laser beam in accordance with an illustrative embodiment;

FIG. 15 is an illustration of a flowchart of a process for deicing a laser sensor window in accordance with an illustrative embodiment;

FIG. 16 is an illustration of a flowchart of a process for deicing a laser sensor window in accordance with an illustrative embodiment;

FIG. 17 is an illustration of a flowchart of a process for determining chemical elements in accordance with an illustrative embodiment;

FIG. 18 is an Illustration of a flowchart of a process for determining chemical elements in accordance with an illustrative embodiment;

FIG. 19 is an illustration of a flowchart of a process for determining ice properties in accordance with an illustrative embodiment;

FIG. 20 is an illustration of a flowchart of a process for deicing a laser sensor window in accordance with an illustrative embodiment;

FIG. 21 is an illustration of an aircraft manufacturing and service method in accordance with an illustrative embodiment; and

FIG. 22 is an illustration of a block diagram of an aircraft in which an illustrative embodiment may be implemented.

### DETAILED DESCRIPTION

The illustrative embodiments recognize and take into account one or more different considerations. An advantage of using laser sensor systems is that instruments protruding from the surface of the aircraft are not present. A laser sensor system is located in the interior aircraft and can emit laser beams and detect the backscatter through a window in the aircraft.

However, one drawback is that ice can form on the window used by the laser sensor system during flight of aircraft. The ice on the window can interfere with the emission and detection of backscatter by the laser sensor system. As a result, the accuracy of measurements can be less than desired due to this interference.

A deicing system can be used to remove the ice from a window through which laser beams are emitted by the laser sensor system. However, currently used technologies for deicing windows and aircraft are not conducive with using laser sensor systems. For example, deicing systems on the windshield of a cockpit can include interlayers as between the acrylic plies in the window. These interlayers can prevent ice from forming. Further, these interlayers can also conduct heat to melt ice that forms on a window.

However, these currently used windows with deicing features have multiple layers and structures that interfere with the transmission of laser beams from a laser sensor system. For example, currently used windows can produce unwanted laser beam absorption, laser beam decoherence, and backscatter.

Thus, the illustrative examples provide a method, apparatus, and system for deicing laser sensor windows used by laser sensor systems. Thus, the illustrative examples provide a method, apparatus, and system for deicing laser sensor windows. In one illustrative example, a method deices a laser sensor window in an aerospace vehicle. A deicing laser beam is transmitted from a laser beam generator in the aerospace vehicle into the laser sensor window. The deicing laser beam has properties that remove ice from the laser sensor window. A sensor laser beam is transmitted from the laser beam generator through the laser sensor window.

As a result, issues with ice forming on windows used by laser sensor systems can be reduced using a deicing laser. Further, the illustrative examples enable simultaneous operation of a laser sensor system to detect parameters while also deicing the laser sensor window in an aerospace vehicle. Further, the deicing laser beams can be selected to melt ice on a laser sensor window using an eye-safe infrared light that can be absorbed by ice. In some illustrative examples, infrared light can be 1550 nm.

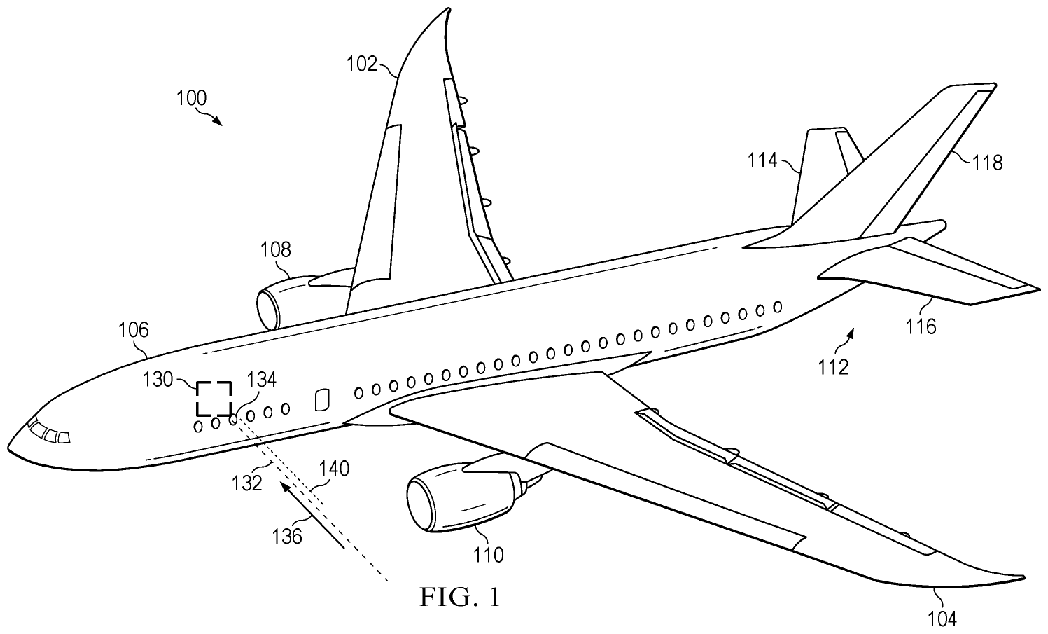

With reference now to the figures, and in particular, with reference to FIG. 1, an illustration of an aircraft is depicted in accordance with an illustrative embodiment. In this illustrative example, commercial airplane 100 has wing 102 and wing 104 attached to body 106. Commercial airplane 100 includes engine 108 attached to wing 102 and engine 110 attached to wing 104.

Body 106 has tail section 112. Horizontal stabilizer 114, horizontal stabilizer 116, and vertical stabilizer 118 are attached to tail section 112 of body 106.

Commercial airplane 100 is an example of an aircraft in which laser sensor system 130 can be implemented in accordance with an illustrative embodiment. Laser sensor system 130 can be a light detection and ranging (LIDAR) system.

In this illustrative example, laser sensor system 130 can operate to emit sensor laser beam 132 from laser sensor window 134 and detect backscatter light 136 generated in response to emitting sensor laser beam 132. Sensor laser beam 132 and backscatter light 136 detected in response to sensor laser beam 132 can be compared to determine information about at least one of commercial airplane 100 or the environment around commercial airplane 100. For example, laser sensor system 130 can be used to detect speed of commercial airplane 100. As another example, laser sensor system 130 can be used to detect moisture or particles in the atmosphere around commercial airplane 100.

In this illustrative example, laser sensor system 130 also includes a deicing feature in which deicing laser beam 140 can be emitted from laser sensor system 130 into laser sensor window 134 to deice laser sensor window 134. In this example, deicing laser beam 140 is transmitted into laser sensor window 134 such that deicing laser beam passes through laser sensor window 134. In this illustrative example, the use of deicing laser beam 140 can improve the performance of laser sensor system 130. By removing ice that may form on laser sensor window 134 using deicing laser beam 140, the detection of parameters using sensor laser beam 132 can be improved as compared to laser sensor systems that do not have this deicing feature. Removing ice from laser sensor window 134 reduces undesired backscatter that may be caused by sensor laser beam 132 traveling through laser sensor window 134 and encountering ice on laser sensor window 134. Further, this type of deicing system does not require complex structures and layers within a window that can interfere with measurements made using a laser sensor system.

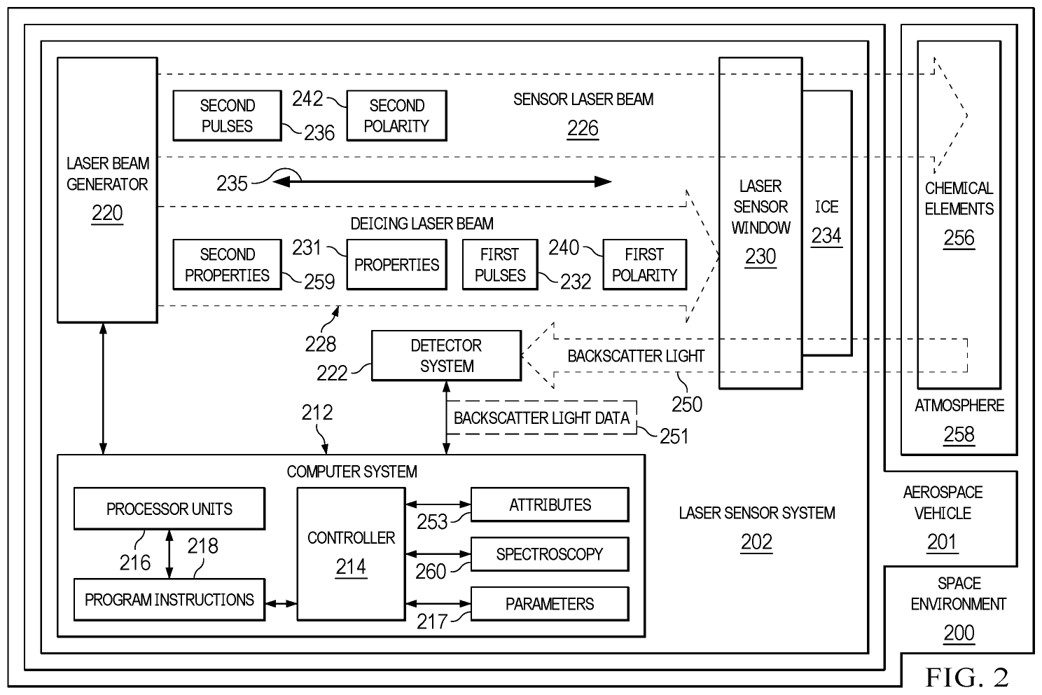

With reference now to FIG. 2, an illustration of a block diagram of a laser sensor environment is depicted in accordance with an illustrative embodiment. In this illustrative example, space environment 200 is an environment in which parameters 217 for at least one of aerospace vehicle 201 or space environment 200 around aerospace vehicle 201 can be determined. Space environment 200 can be at least one of the atmosphere or space outside of Earth's atmosphere.

In this example, these parameters can be detected using laser sensor system 202 in aerospace vehicle 201. Parameters 217 can be selected from at least one of one of a speed, a direction of travel, a temperature, air density, an angle of sideslip, an angle of attack, a presence of a group of objects, aerosol particles concentration, aerosol properties, cloud properties, wind direction, atmospheric temperature, or other suitable parameters.

Aerospace vehicle 201 can take a number of different forms. For example, be selected from at least one of a commercial airplane, a cargo airplane, a tilt-rotor aircraft, a tilt wing aircraft, a vertical takeoff and landing aircraft, an electrical vertical takeoff and landing vehicle, a personal air vehicle, a drone, a rotorcraft, a helicopter, a spacecraft, a satellite, a space shuttle, or other suitable types of vehicles that can operate in at least one of the Earth's atmosphere or space.

As used herein, “a number of” when used with reference to items, means one or more items. For example, “a number of different forms” is one or more different forms.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

In this illustrative example, laser sensor system 202 is comprised of a number of different components. As depicted, laser sensor system 202 includes laser beam generator 220, detector system 222, computer system 212, and controller 214. In this example, controller 214 is located in computer system 212.

Controller 214 can be implemented in software, hardware, firmware or a combination thereof. When software is used, the operations performed by controller 214 can be implemented in program instructions configured to run on hardware, such as a processor unit. When firmware is used, the operations performed by controller 214 can be implemented in program instructions and data and stored in persistent memory to run on a processor unit. When hardware is employed, the hardware can include circuits that operate to perform the operations in controller 214.

In the illustrative examples, the hardware can take a form selected from at least one of a circuit system, an integrated circuit, an application-specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field-programmable logic array, a field-programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As depicted, computer system 212 includes a number of processor units 216 that are capable of executing program instructions 218 implementing processes in the illustrative examples. In other words, program instructions 218 are computer-readable program instructions.

As used herein, a processor unit in the number of processor units 216 is a hardware device and is comprised of hardware circuits such as those on an integrated circuit that respond to and process instructions and program code that operate a computer. When the number of processor units 216 executes program instructions 218 for a process, the number of processor units 216 can be one or more processor units that are in the same computer or in different computers. In other words, the process can be distributed between processor units 216 on the same or different computers in computer system 212.

Further, the number of processor units 216 can be of the same type or different types of processor units. For example, the number of processor units 216 can be selected from at least one of a single core processor, a dual-core processor, a multi-processor core, a general-purpose central processing unit (CPU), a graphics processing unit (GPU), a digital signal processor (DSP), or some other type of processor unit.

In this illustrative example, controller 214 can control laser beam generator 220 to emit deicing laser beam 228 into laser sensor window 230 in aerospace vehicle 201. Laser sensor window 230 can be any window in aerospace vehicle 201 used emit laser beams from laser sensor system 202.

Deicing laser beam 228 has properties 231 that remove ice 234 from laser sensor window 230. In this illustrative example, properties 231 can be selected from at least one of wavelength and power for deicing laser beam 228. Properties 231 for deicing laser beam 228 can be selected to cause at least one of fracturing of ice 234, melting of ice 234, vaporizing of ice 234, damaging a bond of ice 234 to laser sensor window 230, or some other effect that can result in the removal of ice 234.

Further, properties 231 for deicing laser beam 228 include a wavelength that is an eye-safe wavelength that is absorbed by ice. For example, the wavelength can be 1500 nm or can be selected from about 700 nm to 2500 nm.

Further, controller 214 controls laser beam generator 220 to transmit sensor laser beam 226 from laser sensor system 202 through laser sensor window 230.

In this example, deicing laser beam 228 can be transmitted in first pulses 232 along axis 235. Further in this example, sensor laser beam 226 can be transmitted in second pulses 236 along axis 235. In this example by being transmitted along axis 235, both deicing laser beam 228 and sensor laser beam 226 can be transmitted on the same axis rather than in directions parallel to axis 235. In this example, first pulses 232 can be interleaved with second pulses 236 to avoid an overlap between first pulses 232 and second pulses 236 when both first pulses 232 and second pulses 236 travel on axis 235.

In another illustrative example, deicing laser beam 228 can have first polarity 240 and sensor laser beam 226 can have second polarity 242. Controller 214 controls laser beam generator 220 transmit deicing laser beam comprises transmitting the deicing laser beam 228 in first pulses 232 along axis 235. Further, controller 214 controls laser beam generator 220 transmit sensor laser beam 226 in second pulses 236 along axis 235. The transmission may or may not be an interleaving of the first pulses 232 and the second pulses 236. In this example, first polarity 240 is orthogonal to second polarity 242.

In this example, polarization of the light in these two laser beams are orthogonal to each other. In this example, the two laser beams are orthogonal to each other when the polarization direction of one laser beam is perpendicular to the polarization direction of the other laser beam by 90 degrees relative to the direction of travel.

In yet another illustrative example, controller 214 controls laser beam generator 220 to transmit deicing laser beam comprises transmitting the deicing laser beam 228 along axis 235. Further, controller 214 controls laser beam generator 220 to transmit sensor laser beam 226 along axis 235. In this example, first polarity 240 is orthogonal to second polarity 242. In this example, the laser beams do not need to be generated using pulses. For example, at least one of the deicing laser beam 228 or sensor laser beam 226 is a continuous-wave laser beam.

In transmitting deicing laser beam 228, controller 214 can control laser beam generator 220 transmit deicing laser beam 228 into laser sensor window 230 in a number of different ways. For example, controller 214 can control laser beam generator 220 to transmit deicing laser beam into laser sensor window 230 by transmitting deicing laser beam 228 through laser sensor window 230.

In another illustrative example, controller 214 can control laser beam generator 220 to transmit deicing laser beam 228 into laser sensor window 230 such that deicing laser beam 228 travels within laser sensor window 230. With this example, deicing laser beam 228 can be transmitted into at least one of an opening in an edge of the laser sensor window 230 or at an angle into a surface of the laser sensor window 230.

In this illustrative example, backscatter light 250 is generated in response to the transmission of at least one of sensor laser beam 226 or deicing laser beam 228. In this example, backscatter light 250 travels through laser sensor window 230. Further, backscatter light 250 also may be reflected back through laser sensor window 230 in response to the presence of ice 234.

Transmitting deicing laser beam 228 into laser sensor window 230 reduces or eliminates backscatter light 250 occurring from ice 234 on laser sensor window 230. As result, increased accuracy in measurements to be made using sensor laser beam 226.

Further, backscatter light 250 resulting from deicing laser beam 228 encountering ice 234 can be used to determine when and whether further deicing is needed. For example, controller 214 can detect backscatter light 250 generated in response to transmitting deicing laser beam 228 using detector system 222. Detector system 222 can generate backscatter light data 251 for attributes 253 of backscatter light 250 in response to detecting the backscatter light 250. For example, detector system 222 can generate at least one of a frequency, a power, or other information about backscatter light 250.

In this example, controller 214 can determine attributes 253 of backscatter light 250 using backscatter light data 251. In this example, attributes 253 can include at least one of time and intensity. Time is the time to detect backscatter light 250 after a laser beam is emitted. Intensity can be determined from the power in backscatter light data 251.

Controller 214 can determine whether the ice 234 is present on laser sensor window 230 based on attributes 253 determined from backscatter light 250. This backscatter light can be from the transmission of sensor laser beam 226 for deicing laser beam 228.

In one example, if the time is less than a threshold, then ice 234 is considered to be present on laser sensor window 230. As another example, if intensity is less than a threshold, then ice 234 is considered to be absent on laser sensor window 230.

This determination can be used to initiate deicing, continue deicing, or halt deicing. For example, controller 214 can halt transmitting of deicing laser beam 228 in response to a determination that ice 234 is absent on laser sensor window 230.

In the illustrative example, deicing laser beam 228 can have a dual purpose. In addition to being used to deice laser sensor window 230 in response to presence of ice 234 on laser sensor window 230, deicing laser beam 228 can be used to determine information about atmosphere 258 around aerospace vehicle 201.

For example, in response to determining that ice 234 is present on laser sensor window 230 in an insufficient amount to degrade performance in using sensor laser beam 226 to detect a set of parameters 217 for the aerospace vehicle, controller 214 controls laser beam generator 220 to transmit deicing laser beam 228 from laser beam generator 220 into laser sensor window 230. In this example, deicing laser beam 228 generates backscatter light 250 in response to deicing laser beam 228 encountering ice 234 on laser sensor window 230. Further, deicing laser beam 228 has second properties 259 that generate backscatter light 250 for detecting chemical elements 256 in atmosphere 258. In this example, second properties 259 can also be selected from at least one of wavelength or power. These properties are selected specifically to obtain information about chemical elements 256. For example, wavelength can be selected from which backscatter light 250 can indicate the presence of specific chemical elements.

Controller 214 determines chemical elements 256 in atmosphere 258 using backscatter light 250 detected by detector system 222 in response to transmitting deicing laser beam 228 having second properties 259. In this example, controller 214 can determine chemical elements 256 in atmosphere 258 using spectroscopy 260 and backscatter light 250.

In this example, controller 214 can determine properties of ice 234 using attributes 253 of backscatter light 250. These properties can be used to determine chemical elements 256. Ice 234 forms on laser sensor window 230 from moisture in atmosphere 258 in which atmosphere 258 contains chemical elements 256.

The illustration of space environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, laser sensor system 202 can emit one or more sensor laser beams in addition to sensor laser beam 226. In yet another example, laser beam generator 220 can emit one or more deicing laser beams in addition to deicing laser beam 228. Further, other components can be present but not shown such as a telescope, and other components used to propagate the laser beam within laser sensor system 202 for emission into laser sensor window 230. These other components can include, for example, a circulator, a wavelength division multiplexing (WDM) system, and other suitable components.

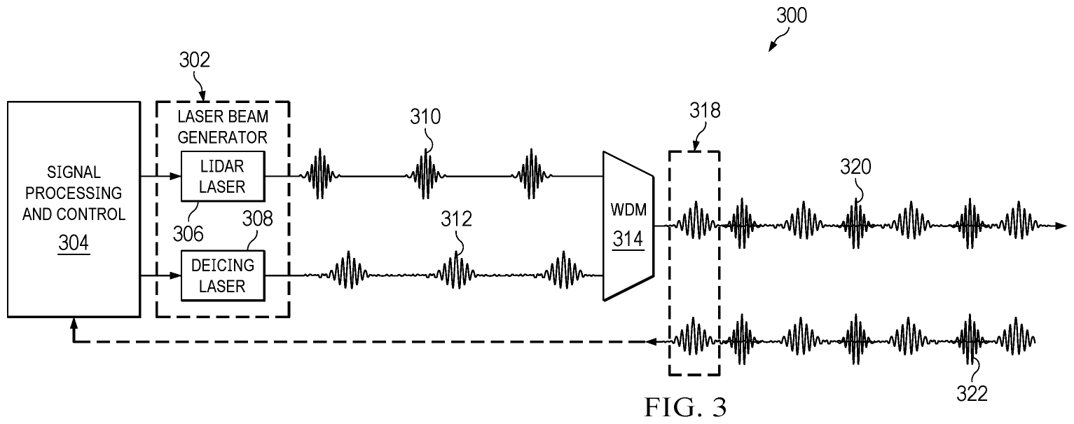

With reference now to FIG. 3, an illustration of a laser sensor system with automatic deicing is depicted in accordance with an illustrative embodiment. Laser sensor system 300 is an example of an implementation for laser sensor system 202 in FIG. 2.

Laser sensor system 300 comprises laser beam generator 302, signal processing and control 304, and wavelength division multiplexing (WDM) unit 314. These components can operate to deice laser sensor window 318.

In this example, laser beam generator 302 is controlled by signal processing and control 304. Laser beam generator 302 is an example of laser beam generator 220 and signal processing and control 304 is an example of an implementation for controller 214 and detector system 222 in FIG. 2. As depicted, laser beam generator 302 comprises lidar laser 306 and deicing laser 308. In this example, laser beams are pulsed laser beams in which pulses of coherent light are emitted.

As depicted, lidar laser 306 emits a laser beam in the form of sensor laser beam pulses 310. Deicing laser 308 emits a laser beam in the form of deicing laser beam pulses 312. These laser beams pulses are combined by wavelength division multiplexing (WDM) unit 314. This unit combines multiple optical signals for transmission.

In this example, these laser beam pulses are combined into wavelength division multiplexing (WDM) unit 314 and emitted as interleaved laser beam pulses 320 into laser sensor window 318. This interleaving of sensor laser beam pulses 310 and deicing laser beam pulses 312 avoids nonlinear effects on those laser beam pulses traveling through laser sensor window 318.

Backscatter light 322 is generated in response to interleaved laser beam pulses 320 and travels back through laser sensor window 318. Backscatter light 322 is detected by system signal processing and control 304. In this example, system signal processing and control 304 can perform filtering of backscatter light 322 using at least one of time domain filtering or frequency domain filtering to separate the backscatter light into backscatter light for sensor laser beam pulses 310 and deicing laser beam pulses 312.

In this example, deicing laser beam pulses 312 have properties that are selected to deice laser sensor window 318 when ice is present on laser sensor window 318. Sensor laser beam pulses 310 have properties that are used to determine parameters about the atmosphere around an aerospace vehicle in which laser sensor system 300 is located.

Deicing laser beam pulses 312 have properties selected to deice laser sensor window 318. In this example, the properties for deicing laser beam pulses 312 are selected to cause at least one of fracturing of the ice, melting of the ice, vaporizing of the ice, or damaging a bond of the ice to the laser sensor window. These properties can include at least one of a wavelength or power for deicing laser beam pulses 312.

The depiction of laser sensor system 300 in FIG. 3 is a simplified depiction to emphasize the manner in which laser beams can be emitted as interleaved laser beam pulses. This illustration is not meant to limit the manner in which other illustrative examples can be implemented. Other components can be present but not shown such as optical fibers, circulators, amplifiers, and other components used in laser sensor systems.

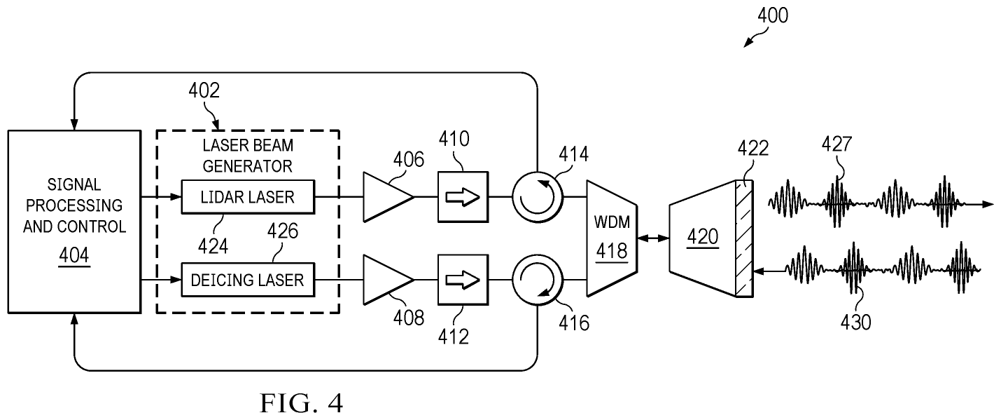

With reference to FIG. 4, an illustration of a more detailed example of a laser sensor system is depicted in accordance with an illustrative embodiment. In this illustrative example, laser sensor system 400 is an example of an implementation for laser sensor system 202 in FIG. 2 and is a more detailed example of laser sensor system 300 in FIG. 3.

As depicted, laser sensor system 400 comprises laser beam generator 402, signal processing and control 404, amplifier 406, amplifier 408, isolator 410, isolator 412, circulator 414, circulator 416, wavelength division multiplexing (WDM) unit 418, and telescope 420. These different components can be connected to each other by optical fiber cables. In some examples, an air interface can be present between components such as wavelength division multiplexing (WDM) unit 418 and telescope 420. These components can operate to deice laser sensor window 422 in addition to detecting parameters about the environment around the aerospace vehicle in which laser sensor system 400 is located.

In this illustrative example, signal processing and control 404 operates to control the operation of laser beam generator 402. In this example, laser beam generator 402 comprises lidar laser 424 and deicing laser 426. These two lasers are laser sources that generate laser beams. In this example, the laser beams are pulsed laser beams.

As depicted, the output of lidar laser 424 is connected to amplifier 406. This amplifier operates to increase or boost the power of a laser beam generated by lidar laser 424. The output of the deicing laser 426 is connected to amplifier 408, which operates to increase or boost the power of the laser beam generated by deicing laser 426. In this example, the output of amplifier 406 is connected to isolator 410. This isolator controls the direction of light for a pulsed laser beam generated by lidar laser 424. Isolator 412 is connected to the output of amplifier 408 and controls the direction of light for a pulsed laser beam generated by deicing laser 426.

In this example, circulator 414 is connected to isolator 410 and circulator 416 is connected to isolator 412. These circulators are optical circulators and, in this example, take the form of three-port devices. In this example, the light entering a port exits on the next port in the circulator.

Circulator 414 and circulator 416 are also both connected to signal processing and control 404 and wavelength division multiplexing (WDM) unit 418. Wavelength division multiplexing (WDM) unit 418 is connected to telescope 420.

In this example, wavelength division multiplexing (WDM) unit 418 combines pulsed laser beams generated by lidar laser 424 and deicing laser 426 into interleaved laser beam pulses 427 that are emitted by telescope 420. In this example, telescope 420 is an optical device that transmits interleaved laser beam pulses 427. Additionally, telescope 420 can also operate as a receiver and receive backscatter light 430 generated in response to interleaved laser beam pulses 427.

In this example, backscatter light 430 is split between circulator 414 and circulator 416 by wavelength division multiplexing (WDM) unit 418 on at least one of a time domain or frequency. In this manner, circulator 414 receives backscatter light 430 generated in response to laser beam pulses originating from lidar laser 424. Circulator 416 receives backscatter light 430 generated in response to laser beam pulses originating from deicing laser 426.

The circulators route the backscatter light 430 to signal processing and control 404 for detection and analysis. In other words, signal processing and control 404 can generate backscatter light data in response to detecting the backscatter light. Further, signal processing and control 404 can analyze this backscatter light data.

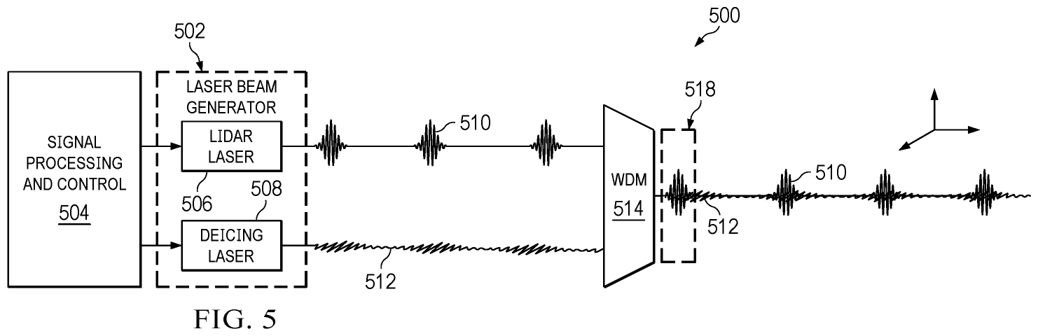

With reference next to FIG. 5, an illustration of laser beam transmission using orthogonal pulsed laser beams is depicted in accordance with an illustrative embodiment. In this example, laser sensor system 500 is an example of an implementation for laser sensor system 202 in FIG. 2.

As depicted, laser sensor system 500 comprises laser beam generator 502, signal processing and control 504, and wavelength division multiplexing (WDM) unit 514. These components can operate to deice laser sensor window 518.

In this example, laser beam generator 502 is controlled by signal processing and control 504. Laser beam generator 502 is an example of laser beam generator 220 and signal processing and control 504 is an example of an implementation for controller 214 and laser sensor system 202 in FIG. 2. As depicted, laser beam generator 502 comprises lidar laser 506 and deicing laser 508.

In this illustrative example, the laser beams are pulsed laser beams in which pulses of coherent light are emitted from the lasers. For example, lidar laser 506 emits sensor laser beam pulses 510. Deicing laser 508 emits deicing laser beam pulses 512. Further In this example, the polarization of the light in these two laser beams is orthogonal to each other in which the polarization direction of sensor laser beam pulses 510 is perpendicular to the polarization direction of deicing laser beam pulses 512 by 90 degrees relative to the direction of travel.

With these two laser beam pulses being orthogonal to each other, the laser beam pulses can be emitted without interleaving the laser beam pulses as depicted in this example. Interleaving is unnecessary in this case because sensor laser beam pulses 510 and deicing laser beam pulses 512 do not interfere with each other even though an overlap is present because polarization of the two sets of laser beam pulses are orthogonal to each other.

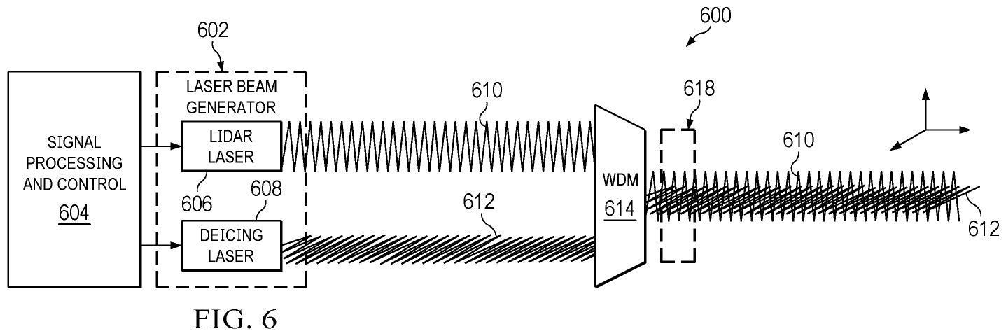

Turning now to FIG. 6, an illustration of laser beam transmission using orthogonal continuous wave laser beams is depicted in accordance with an illustrative embodiment. In this example, laser sensor system 600 is an example of an implementation for laser sensor system 202 in FIG. 2.

As depicted, laser sensor system 600 comprises laser beam generator 602, signal processing and control 604, and wavelength division multiplexing (WDM) unit 614. These components can operate to deice laser sensor window 618.

In this example, laser beam generator 602 is controlled by signal processing and control 604. Laser beam generator 602 is an example of laser beam generator 220 and signal processing and control 604 is an example of an implementation for controller 214 and laser sensor system 202 in FIG. 2. As depicted, laser beam generator 602 comprises lidar laser 606 and deicing laser 608.

In this example, laser beams are continuous wave laser beams in which coherent light is emitted continuously from the two lasers. For example, lidar laser 606 emits a continuous wave sensor laser beam 610. Deicing laser 608 emits continuous wave deicing laser beam 612. In this example, polarization of the light in these two continuous wave laser beams are orthogonal to each other in which the polarization direction of continuous wave sensor laser beam 610 is perpendicular to the polarization direction of continuous wave deicing laser beam 612 by 90 degrees relative to the direction of travel.

With these two continuous wave laser beams being orthogonal to each other, the two continuous wave laser beams can be emitted without interleaving as depicted in this example. Interleaving is unnecessary in this case because continuous wave sensor laser beam 610 and continuous wave deicing laser beam 612 as depicted do not interfere with each other because polarization of the two sets of continuous wave laser beam pulses are orthogonal to each other.

Illustration of the emission of laser beams in FIG. 5 and FIG. 6 are provided as some examples of emitting laser beams that are orthogonal to each other. In other illustrative examples, one laser beam is a continuous wave laser beam while another laser beam is pulsed laser beam. In these and other illustrative examples, orthogonal continuous wave beams do not experience nonlinear effects with respect to each other.

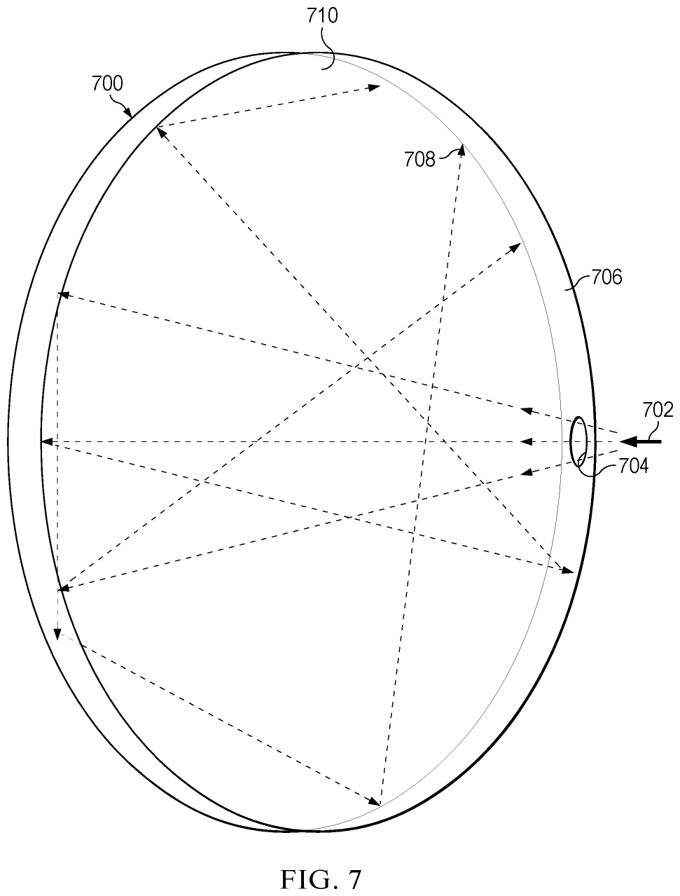

With reference next to FIG. 7, an illustration of transmitting a deicing laser beam into a laser sensor window is depicted in accordance with an illustrative embodiment. In this illustrative example, laser sensor window 700 is an example of one implementation for laser sensor window 230 in FIG. 2.

In this example, the deicing laser beam 702 is transmitted into laser sensor window 700 through opening 704 in edge 706 of laser sensor window 700. Deicing laser beam 702 is not transmitted through planar surface 710 of laser sensor window 700 in this example.

In this example, edge 706 is reflective such that the deicing laser beam 702 travels within laser sensor window 700. A coating on edge 706 such as aluminum, silver, and other suitable materials for reflecting light can be used to provide reflectivity on edge 706.

As depicted, deicing laser beam 702 can be transmitted into laser sensor window 700 to travel in the direction of arrows 708. The deicing laser beam 702 continues to travel without undesired energy loss until encountering ice that may be located on planar surface 710 of laser sensor window 700.

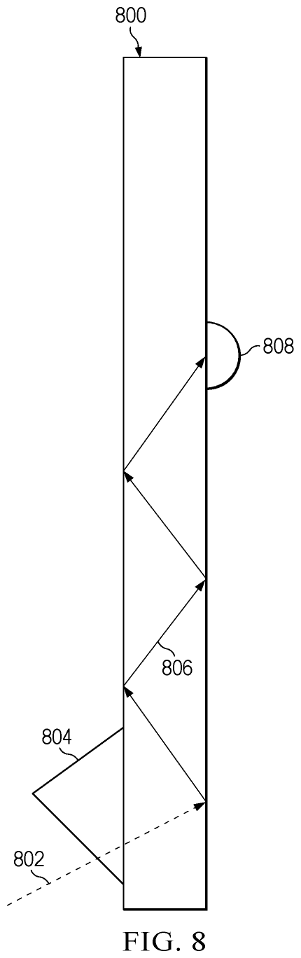

Turning to FIG. 8, an illustration of transmitting a deicing laser beam into a laser sensor window is depicted in accordance with an illustrative embodiment. In this illustrative example, laser sensor window 800 is an example of one implementation for laser sensor window 230 in FIG. 2. Laser sensor window 800 is shown in a side view.

In this example, the deicing laser beam 802 can be emitted into laser sensor window 800 without deicing laser beam 802 passing through laser sensor window 800. In this example, deicing laser beam 802 is emitted through prism 804 into laser sensor window 800. In this example, deicing laser beam 802 travels within laser sensor window 800 through internal inflection as shown by arrow 806.

Deicing laser beam 802 travels internally within laser sensor window 800 until deicing laser beam 802 attenuates. In response to deicing laser beam 802 encountering ice 808, the deicing laser beam 802 can cause at least one of fracturing of ice 808, melting of ice 808, vaporizing of ice 808, or damaging a bond of ice 808 to laser sensor window 800.

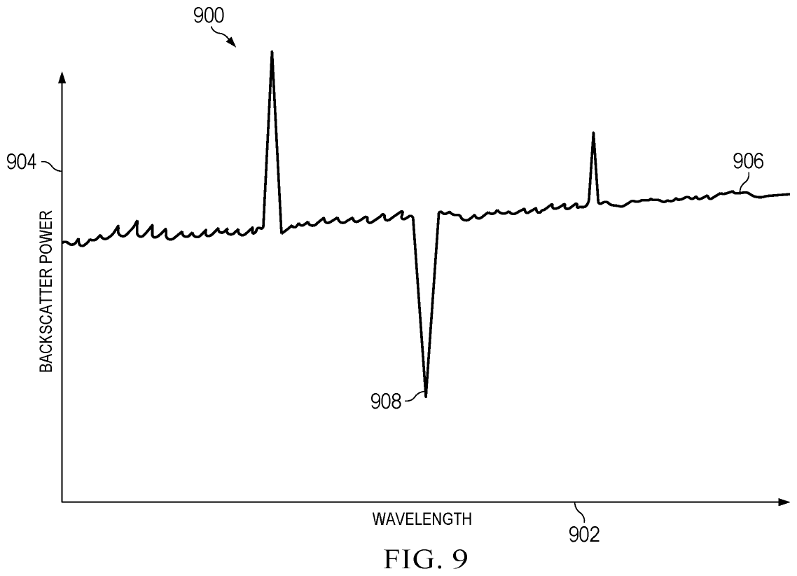

In FIG. 9, an illustration of an ice fingerprint is depicted in accordance with an illustrative embodiment. In this example, graph 900 represents an ice fingerprint generated from detecting the backscatter resulting from a deicing laser beam encountering ice on a laser sensor window.

In this example, x-axis 902 represents wavelength. Y-axis 904 represents backscatter power. Line 906 is a representation of the backscatter received from the deicing laser beam encountering ice. Line 906 is an optical fingerprint of the ice.

The ice on the laser sensor window contains trace elements of the atmosphere. As trace elements can be, for example, pollution, greenhouse gases, ash, and other elements. Information about these trace elements can be determined from line 906. For example, with environmental gas, identification of the gases and concentrations can be determined. In this example, point 908 on line 906 can indicate absorption of the deicing laser beam by a chemical element.

As a result, using the deicing laser sensor beam to generate backscatter to identify the optical fingerprint of the ice can be used to determine properties of the atmosphere in which the ice was formed.

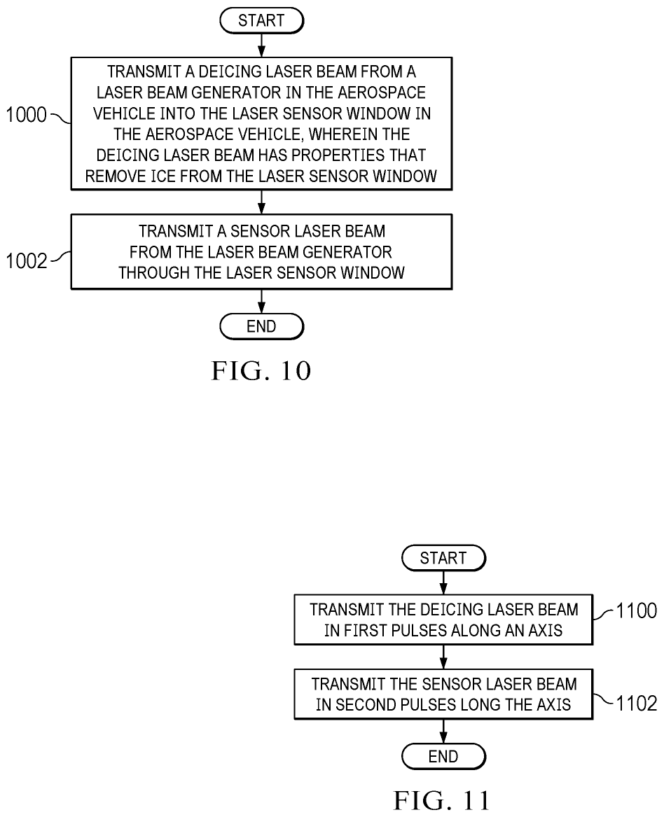

Turning next to FIG. 10, an illustration of a flowchart of a process for deicing a laser sensor window in aerospace vehicle is depicted in accordance with an illustrative embodiment. The process in FIG. 10 can be implemented in hardware, software, or both. When implemented in software, the process can take the form of program instructions that are run by one of more processor units located in one or more hardware devices in one or more computer systems. For example, the process can be implemented in controller 214 in laser sensor system 202 in FIG. 2. In these examples, the controller can control different components within the laser sensor system to perform deicing as well as other operations in an aerospace vehicle.

The process begins by transmitting a deicing laser beam from a laser beam generator in the aerospace vehicle into the laser sensor window in the aerospace vehicle, wherein the deicing laser beam has properties that remove ice from the laser sensor window (operation 1000). In operation 1000, the properties for the deicing laser beam can be selected to cause at least one of fracturing of the ice, melting of the ice, vaporizing of the ice, damaging a bond of the ice to the laser sensor window, or some other suitable action resulting in deicing of the laser sensor window. The properties can be selected from at least one of a wavelength, a laser beam power, or some other suitable property. Further in this example, the properties for the deicing laser beam can include a wavelength is an eye-safe wavelength that is absorbed by ice.

The process transmits a sensor laser beam from the laser beam generator through the laser sensor window (step 1002). The process terminates thereafter.

With reference now to FIG. 11, an illustration of a flowchart of a process for deicing a laser sensor window is depicted in accordance with an illustrative embodiment. The different operations in this flowchart are an example of an implementation for operation 1000 and operation 1002 in FIG. 10.

The process transmits the deicing laser beam in first pulses along an axis (operation 1100). The process transmits the sensor laser beam in second pulses along the axis (operation 1102). The process terminates thereafter. In this example, the first pulses are interleaved with the second pulses to avoid an overlap between the first pulses and the second pulses. In this flowchart, operation 1100 is an example of operation 1000 in FIG. 10 and operation 1102 is an example of an implementation for operation 1002 in FIG. 10.

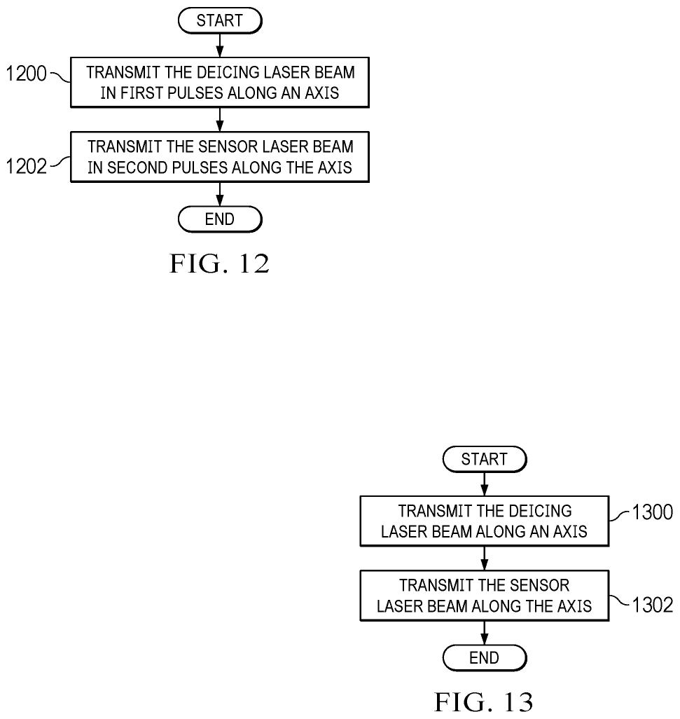

Turning to FIG. 12, an illustration of a flowchart of a process for deicing a laser sensor window is depicted in accordance with an illustrative embodiment. The different operations in this flowchart are an example of an implementation for operation 1000 and operation 1002 in FIG. 10.

The process transmits the deicing laser beam in first pulses along an axis (operation 1200). The process transmits the sensor laser beam in second pulses along the axis (operation 1202). The process terminates thereafter. In this example, a first polarity of the first pulses are orthogonal to a second polarity of the second pulses. In this flowchart, operation 1200 is an example of operation 1000 in FIG. 10 and operation 1202 is an example of an implementation for operation 1002 in FIG. 10.

In FIG. 13, an illustration of a flowchart of a process for deicing a laser sensor window is depicted in accordance with an illustrative embodiment. The different operations in this flowchart are an example of an implementation for operation 1000 and operation 1002 in FIG. 10.

The process transmits the deicing laser beam along an axis (operation 1300). The process transmits the sensor laser beam along the axis (operation 1302). The process terminates thereafter. In this example, the deicing laser beam has a first polarity that is orthogonal to a second polarity of the sensor laser beam. Further, wherein at least one of the deicing laser beam or the sensor laser beam can be a continuous-wave laser beam. In this flowchart, operation 1300 is an example of operation 1000 in FIG. 10 and operation 1302 is an example of an implementation for operation 1002 in FIG. 10.

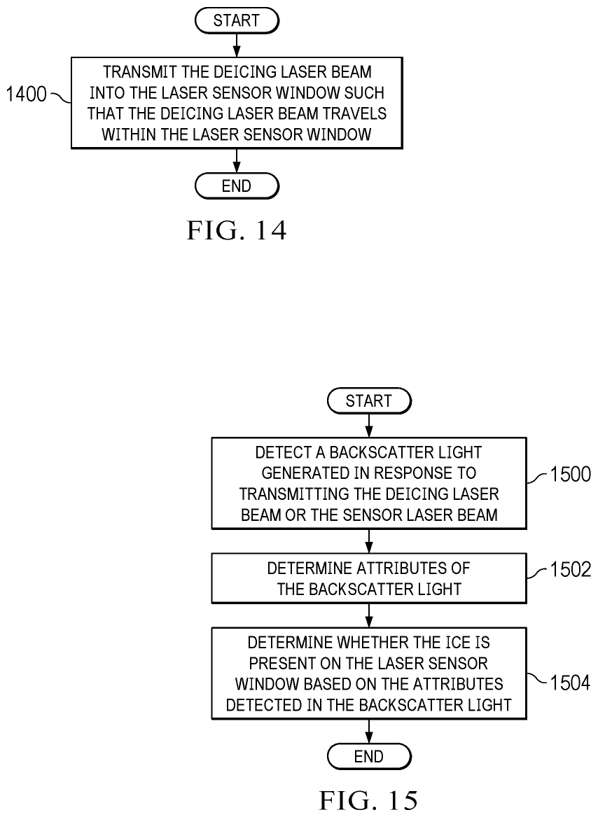

Turning now to FIG. 14, an illustration of a flowchart of process for transmitting a deicing laser beam is depicted in accordance with an illustrative embodiment. The process in this figure is an example of one implementation for operation 1000 in FIG. 10.

The process transmits the deicing laser beam into the laser sensor window such that the deicing laser beam travels within the laser sensor window (operation 1400). The process terminates thereafter. In operation 1400, the deicing laser beam is transmitted into at least one of an opening in an edge of the laser sensor window or an angle into a surface of the laser sensor window.

In FIG. 15, an illustration of a flowchart of a process for deicing a laser sensor window is depicted in accordance with an illustrative embodiment. The operations performed in this flowchart are examples of additional operations that can be performed with the operations in FIG. 10.

The process begins by detecting a backscatter light generated in response to transmitting the deicing laser beam or the sensor laser beam (operation 1500). The process determines attributes of the backscatter light (operation 1502).

The process determines whether the ice is present on the laser sensor window based on the attributes detected in the backscatter light (operation 1504). The process terminates thereafter.

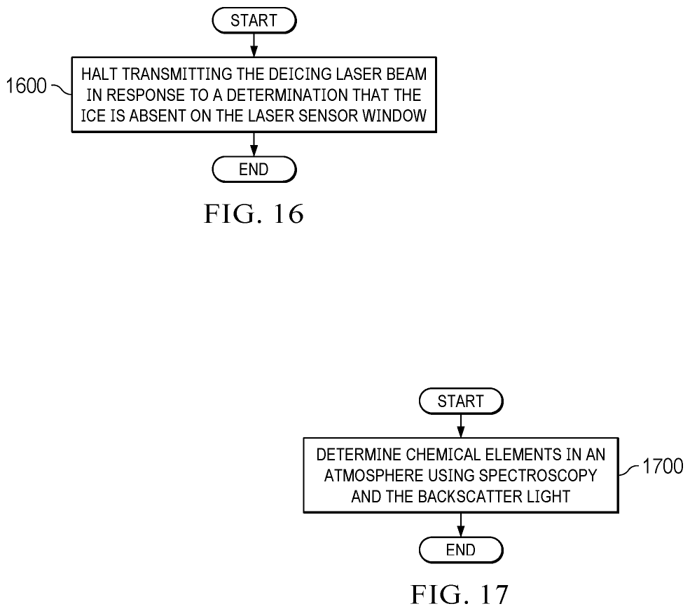

Turning now to FIG. 16, an illustration of a flowchart of process for deicing a laser sensor window is depicted in accordance with an illustrative embodiment. The operation in this figure is an example of an additional operation that can be performed with the operations in FIG. 15.

The process halts transmitting the deicing laser beam in response to a determination that the ice is absent on the laser sensor window (operation 1600). The process terminates thereafter.

With reference next to FIG. 17, an illustration of a flowchart of a process for determining chemical elements is depicted in accordance with an illustrative embodiment. The process illustrated in this figure is an example of an additional operation that can be performed with the operations in FIG. 15.

In response to the determination that the ice is absent on the laser sensor window, the process determines chemical elements in an atmosphere using spectroscopy and the backscatter light (operation 1700). The process terminates thereafter.

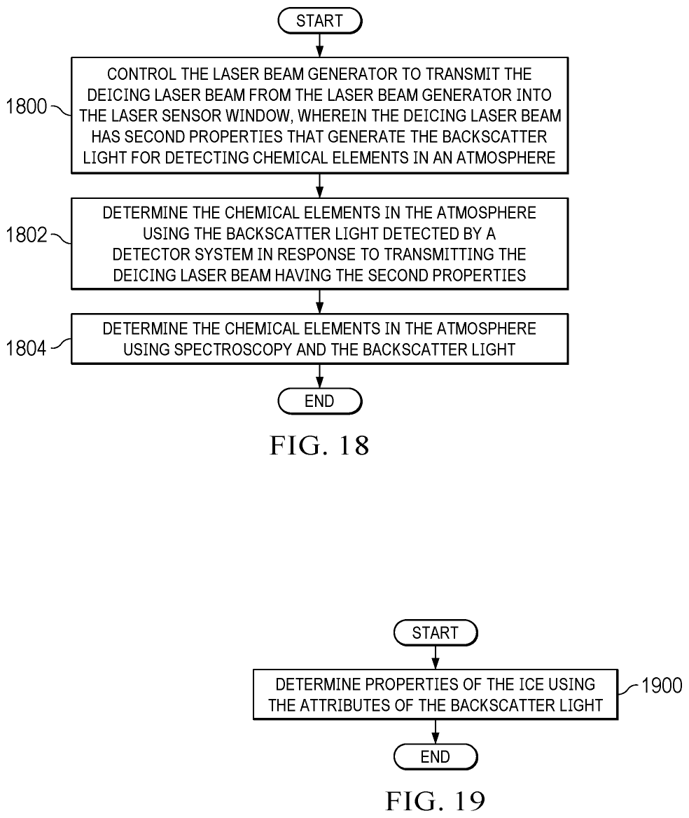

With reference now to FIG. 18, an Illustration of a flowchart of a process for determining chemical elements is depicted in accordance with an illustrative embodiment. The process illustrated in this figure is an example of additional operations that can be performed with the operations in FIG. 15.

In response to determining that the ice is present on the laser sensor window in an insufficient amount to degrade performance in using the sensor laser beam to detect a set of parameters for the aerospace vehicle, the process controls the laser beam generator to transmit the deicing laser beam from the laser beam generator into the laser sensor window, wherein the deicing laser beam has second properties that generate the backscatter light for detecting chemical elements in an atmosphere (operation 1800). The process determines the chemical elements in the atmosphere using the backscatter light detected by a detector system in response to transmitting the deicing laser beam having the second properties (operation 1802).

The process determines the chemical elements in the atmosphere using spectroscopy and the backscatter light (operation 1804). The process terminates thereafter.

Turning next to FIG. 19, an illustration of a flowchart of process for determining ice properties is depicted in accordance with an illustrative embodiment. The process illustrated in this figure is an is an example of an additional operation that can be performed with the operations in FIG. 15.

The process determines properties of the ice using the attributes of the backscatter light (operation 1900). The process terminates thereafter.

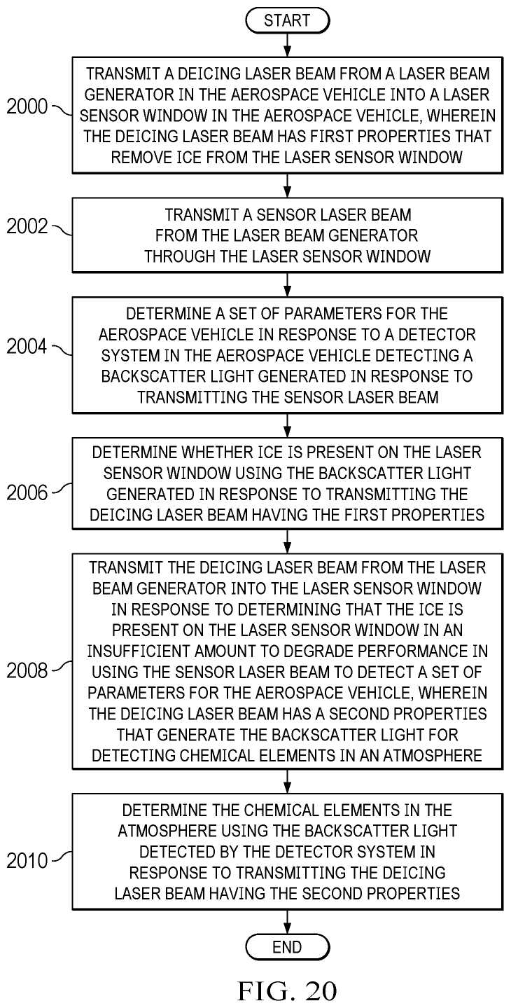

Next in FIG. 20, an illustration of a flowchart of process for deicing a laser sensor window is depicted in accordance with an illustrative embodiment. The process in FIG. 20 can be implemented in hardware, software, or both. When implemented in software, the process can take the form of program instructions that are run by one of more processor units located in one or more hardware devices in one or more computer systems. For example, the process can be implemented in controller 214 in laser sensor system 202 in FIG. 2. In these examples, the controller can control different components within the laser sensor system to perform deicing as well as other operations in an aerospace vehicle.

The process begins by transmitting a deicing laser beam from a laser beam generator in the aerospace vehicle into a laser sensor window in the aerospace vehicle, wherein the deicing laser beam has first properties that remove ice from the laser sensor window (operation 2000). The process transmits a sensor laser beam from the laser beam generator through the laser sensor window (operation 2002).

The process determines a set of parameters for the aerospace vehicle in response to a detector system in the aerospace vehicle detecting a backscatter light generated in response to transmitting the sensor laser beam (operation 2004). The process determines whether ice is present on the laser sensor window using the backscatter light generated in response to transmitting the deicing laser beam having the first properties (operation 2006).

The process transmits the deicing laser beam from the laser beam generator into the laser sensor window in response to determining that the ice is present on the laser sensor window in an insufficient amount to degrade performance in using the sensor laser beam to detect a set of parameters for the aerospace vehicle, wherein the deicing laser beam has a second properties that generate the backscatter light for detecting chemical elements in an atmosphere (operation 2008). The process determines the chemical elements in the atmosphere using the backscatter light detected by the detector system in response to transmitting the deicing laser beam having the second properties (operation 2010). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program instructions, hardware, or a combination of the program instructions and hardware. When implemented in hardware, the hardware can, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

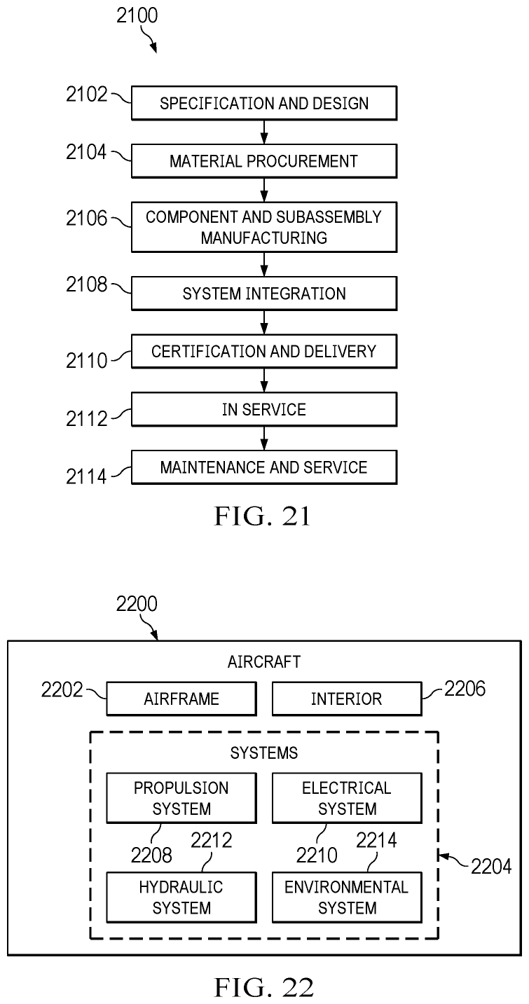

Illustrative embodiments of the disclosure may be described in the context of aircraft manufacturing and service method 2100 as shown in FIG. 21 and aircraft 2200 as shown in FIG. 22. Turning first to FIG. 21, an illustration of an aircraft manufacturing and service method is depicted in accordance with an illustrative embodiment. During pre-production, aircraft manufacturing and service method 2100 may include specification and design 2102 of aircraft 2200 in FIG. 22 and material procurement 2104.

During production, component and subassembly manufacturing 2106 and system integration 2108 of aircraft 2200 in FIG. 22 takes place. Thereafter, aircraft 2200 in FIG. 22 can go through certification and delivery 2110 in order to be placed in service 2112. While in service 2112 by a customer, aircraft 2200 in FIG. 22 is scheduled for routine maintenance and service 2114, which may include modification, reconfiguration, refurbishment, and other maintenance or service.

Each of the processes of aircraft manufacturing and service method 2100 may be performed or carried out by a system integrator, a third party, an operator, or some combination thereof. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 22, an illustration of an aircraft is depicted in which an illustrative embodiment may be implemented. In this example, aircraft 2200 is produced by aircraft manufacturing and service method 2100 in FIG. 21 and may include airframe 2202 with plurality of systems 2204 and interior 2206. Examples of systems 2204 include one or more of propulsion system 2208, electrical system 2210, hydraulic system 2212, and environmental system 2214. Any number of other systems may be included. Although an aerospace example is shown, different illustrative embodiments may be applied to other industries, such as the automotive industry.

Apparatuses and methods embodied herein may be employed during at least one of the stages of aircraft manufacturing and service method 2100 in FIG. 21.

In one illustrative example, components or subassemblies produced in component and subassembly manufacturing 2106 in FIG. 21 can be fabricated or manufactured in a manner similar to components or subassemblies produced while aircraft 2200 is in service 2112 in FIG. 21. As yet another example, one or more apparatus embodiments, method embodiments, or a combination thereof can be utilized during production stages, such as component and subassembly manufacturing 2106 and system integration 2108 in FIG. 21. One or more apparatus embodiments, method embodiments, or a combination thereof may be utilized while aircraft 2200 is in service 2112, during maintenance and service 2114 in FIG. 21, or both. The use of a number of the different illustrative embodiments may substantially expedite the assembly of aircraft 2200, reduce the cost of aircraft 2200, or both expedite the assembly of aircraft 2200 and reduce the cost of aircraft 2200.

In these illustrative examples, the addition and use of laser sensor system 202 can improve the performance of aircraft 2200 can detecting parameters for at least one of aircraft 2200 or the environment around aircraft 2200. The different illustrative examples can reduce issues caused by icing on windows through which laser beams are emitted. The addition of laser sensor system 202 or components to current laser sensor systems during modification, reconfiguration, refurbishment, and other maintenance or service.

Thus, the illustrative examples provide a method, apparatus, and system for deicing laser sensor windows. In one illustrative example, a method deices a laser sensor window in an aerospace vehicle. A deicing laser beam is transmitted from a laser beam generator in the aerospace vehicle into the laser sensor window. The deicing laser beam has properties that remove ice from the laser sensor window. A sensor laser beam is transmitted from the laser beam generator through the laser sensor window.

As a result, issues with ice forming on windows used by laser sensor systems, such as layer systems can be reduced using a deicing laser. Further, the illustrative examples enable simultaneous operation of laser sensor system to detect parameters while deicing the laser sensor window can aerospace vehicle. Further, the deicing laser beams can be selected to melt ice on a laser sensor window using an eye safe infrared light that can be absorbed by ice. In some illustrative examples, infrared light can be 1550 nm.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method for deicing a laser sensor window in an aerospace vehicle, the method comprising:
transmitting a deicing laser beam from a laser beam generator in the aerospace vehicle into the laser sensor window, wherein the deicing laser beam has properties that remove ice from the laser sensor window; and
transmitting a sensor laser beam from the laser beam generator through the laser sensor window.

2. The method of claim 1, wherein:
said transmitting the deicing laser beam comprises transmitting the deicing laser beam in first pulses along an axis; and
said transmitting the sensor laser beam comprises transmitting the sensor laser beam in second pulses along the axis;
wherein the first pulses are interleaved with the second pulses to avoid an overlap between the first pulses and the second pulses.

3. The method of claim 1, wherein:
said transmitting the deicing laser beam comprises transmitting the deicing laser beam in first pulses along an axis; and
said transmitting the sensor laser beam comprises transmitting the sensor laser beam in second pulses along the axis;
wherein a first polarity of the first pulses are orthogonal to a second polarity of the second pulses.

4. The method of claim 1, wherein:
said transmitting the deicing laser beam comprises transmitting the deicing laser beam along an axis; and
said transmitting the sensor laser beam comprises transmitting the sensor laser beam along the axis;
wherein the deicing laser beam has a first polarity that is orthogonal to a second polarity of the sensor laser beam.

5. The method of claim 4, wherein at least one of the deicing laser beam or the sensor laser beam is a continuous-wave laser beam.

6. The method of claim 1, wherein said transmitting the deicing laser beam comprises transmitting the deicing laser beam into the laser sensor window such that the deicing laser beam travels within the laser sensor window.

7. The method of claim 6, wherein the deicing laser beam is transmitted into at least one of an opening in an edge of the laser sensor window or an angle into a surface of the laser sensor window.

8. The method of claim 1, further comprising:
detecting a backscatter light generated in response to said transmitting the deicing laser beam or the sensor laser beam;
determining attributes of the backscatter light; and
determining whether the ice is present on the laser sensor window based on the attributes detected in the backscatter light.

9. The method of claim 8, further comprising:
halting said transmitting the deicing laser beam in response to a determination that the ice is absent on the laser sensor window.

10. The method of claim 8, further comprising:
in response to a determination that the ice is absent on the laser sensor window, determining chemical elements in an atmosphere using spectroscopy and the backscatter light.

11. The method of claim 8, further comprising:
in response to determining that the ice is present on the laser sensor window in an insufficient amount to degrade performance in using the sensor laser beam to detect a set of parameters for the aerospace vehicle, controlling the laser beam generator to transmit the deicing laser beam from the laser beam generator into the laser sensor window, wherein the deicing laser beam has second properties that generate the backscatter light for detecting chemical elements in an atmosphere; and
determining the chemical elements in the atmosphere using the backscatter light detected by a detector system in response to transmitting the deicing laser beam having the second properties.

12. The method of claim 8, further comprising:
determining properties of the ice using the attributes of the backscatter light.

13. The method of claim 1, wherein the properties for the deicing laser beam are selected to cause at least one of fracturing of the ice, melting of the ice, vaporizing of the ice, or damaging a bond of the ice to the laser sensor window.

14. The method of claim 13, wherein the properties are selected from at least one of a wavelength or a laser beam power.

15. The method of claim 1, wherein the properties for the deicing laser beam include a wavelength, and wherein the wavelength is selected as an eye-safe wavelength that is absorbed by the ice.

16. A laser sensor system comprising:
a laser beam generator in an aerospace vehicle, wherein the laser beam generator is configured to transmit laser beams;
a detector system in the aerospace vehicle, wherein the detector system is configured to detect a backscatter light received in response to transmitted laser beams;
a controller configured to control the laser beam generator to:
transmit a deicing laser beam from the laser beam generator into a laser sensor window in the aerospace vehicle, wherein the deicing laser beam has properties that remove ice from the laser sensor window; and
transmit a sensor laser beam from the laser beam generator through the laser sensor window.

17. The laser sensor system of claim 16, wherein:
in transmitting the deicing laser beam, the controller is configured to control the laser beam generator to transmit the deicing laser beam in first pulses along an axis; and
in transmitting the sensor laser beam, the controller is configured to control the laser beam generator to transmit the sensor laser beam in second pulses along the axis;
wherein the first pulses are interleaved with the second pulses to avoid an overlap between the first pulses and the second pulses.

18. The laser sensor system of claim 16, wherein:
in transmitting the deicing laser beam, the controller controls the laser beam generator to transmit the deicing laser beam in first pulses along an axis; and
in transmitting the sensor laser beam, the controller controls the laser beam generator to transmit the sensor laser beam in second pulses along the axis;
wherein a first polarity of the first pulses are orthogonal to a second polarity of the second pulses.

19. The laser sensor system of claim 16, wherein:
in transmitting the deicing laser beam, the controller controls the laser beam generator to transmit the deicing laser beam along an axis; and
in transmitting the sensor laser beam, the controller controls the laser beam generator to transmit the sensor laser beam along the axis;
wherein the deicing laser beam has a first polarity that is orthogonal to a second polarity of the sensor laser beam.

20. The laser sensor system of claim 19, wherein at least one of the deicing laser beam or the sensor laser beam is a continuous-wave laser beam.

21. The laser sensor system of claim 16, wherein in transmitting the deicing laser beam, the controller controls the laser beam generator to transmit the deicing laser beam into the laser sensor window such that the deicing laser beam travels within the laser sensor window.

22. The laser sensor system of claim 21, wherein the deicing laser beam is transmitted into at least one of an opening in an edge of the laser sensor window or an angle into a surface of the laser sensor window.

23. The laser sensor system of claim 16, wherein the detector system is configured to detect the backscatter light generated in response to transmitting the deicing laser beam into the laser sensor window, and wherein the controller is further configured to:
determine attributes of the backscatter light; and
determine whether the ice is present on the laser sensor window based on the attributes detected in the backscatter light.

24. The laser sensor system of claim 23, wherein the controller is further configured to:
control the laser beam generator to halt transmitting the deicing laser beam in response to a determination that the ice is absent on the laser sensor window.

25. The laser sensor system of claim 24, wherein the controller is further configured to:
in response to determining that the ice is present on the laser sensor window in an insufficient amount to degrade performance in using the sensor laser beam to detect a set of parameters for the aerospace vehicle, control the laser beam generator to transmit the deicing laser beam from the laser beam generator into the laser sensor window, wherein the deicing laser beam has second properties that generate the backscatter light for detecting chemical elements in an atmosphere; and
determine the chemical elements in the atmosphere using the backscatter light detected by the detector system in response to transmitting the deicing laser beam having the second properties.

26. The laser sensor system of claim 23, wherein the controller is further configured to:
determine properties of the ice using the attributes of the backscatter light.

27. The laser sensor system of claim 16, wherein the properties for the deicing laser beam are selected to cause at least one of fracturing of the ice, melting of the ice, vaporizing of the ice, or damaging a bond of the ice to the laser sensor window.

28. The laser sensor system of claim 27, wherein the properties are selected from at least one of a wavelength or a laser beam power.

29. The laser sensor system of claim 16, wherein the properties for the deicing laser beam include a wavelength, and wherein the wavelength is selected as an eye-safe wavelength that is absorbed by the ice.

30. A laser sensor system comprising:
a laser beam generator in an aerospace vehicle, wherein the laser beam generator is configured to transmit laser beams;
a detector system in the aerospace vehicle, wherein the detector system is configured to detect a backscatter light received in response to transmitted laser beams; and
a controller configured to:
control the laser beam generator to transmit a deicing laser beam from the laser beam generator into a laser sensor window in the aerospace vehicle, wherein the deicing laser beam has first properties that remove ice from the laser sensor window;
control the laser beam generator to transmit a sensor laser beam from the laser beam generator through the laser sensor window;
determine a set of parameters for the aerospace vehicle in response to the detector system detecting the backscatter light generated in response to transmitting the sensor laser beam;
determine whether the ice is present on the laser sensor window using the backscatter light generated in response to transmitting the deicing laser beam having the first properties;
control the laser beam generator to transmit the deicing laser beam from the laser beam generator into the laser sensor window in response to determining that the ice is present on the laser sensor window in an insufficient amount to degrade performance in using the sensor laser beam to detect a set of parameters for the aerospace vehicle, wherein the deicing laser beam has second properties that generate the backscatter light for detecting chemical elements in an atmosphere; and
determine the chemical elements in the atmosphere using the backscatter light detected by the detector system in response to transmitting the deicing laser beam having the second properties.

31. The laser sensor system of claim 30, wherein the first properties for the deicing laser beam are selected to cause at least one of fracturing of the ice, melting of the ice, vaporizing of the ice, or damaging a bond of the ice to the laser sensor window.

32. A method for deicing a laser sensor window in an aerospace vehicle, the method comprising:
transmitting a deicing laser beam from a laser beam generator in the aerospace vehicle into the laser sensor window, wherein the deicing laser beam has first properties that remove ice from the laser sensor window;
transmitting a sensor laser beam from the laser beam generator through the laser sensor window;
determining a set of parameters for the aerospace vehicle in response to a detector system in the aerospace vehicle detecting a backscatter light generated in response to transmitting the sensor laser beam;
determining whether the ice is present on the laser sensor window using the backscatter light generated in response to transmitting the deicing laser beam having the first properties;
transmitting the deicing laser beam from the laser beam generator into the laser sensor window in response to determining that the ice is present on the laser sensor window in an insufficient amount to degrade performance in using the sensor laser beam to detect a set of parameters for the aerospace vehicle, wherein the deicing laser beam has a second properties that generate the backscatter light for detecting chemical elements in an atmosphere; and
determining the chemical elements in the atmosphere using the backscatter light detected by the detector system in response to transmitting the deicing laser beam having the second properties.

33. The method of claim 32, wherein the first properties for the deicing laser beam are selected to cause at least one of fracturing of the ice, melting of the ice, vaporizing of the ice, or damaging a bond of the ice to the laser sensor window.
